(19) United States
(12) Patent Application Publication
(10) Pub. No.: US 2008/0282271 A1
(43) Pub. Date: Nov. 13, 2008

(54) Recording Medium Drive Device

(75) Inventors: Yuji Morita, Saitama (JP); Yoshimitsu Fukushima, Saitama (JP); Hitoshi Nagata, Saitama (JP); Takeshi Kadowaki, Saitama (JP)

Correspondence Address: KRATZ, QUINTOS & HANSON, LLP, 1420 K Street, N.W., Suite 400, WASHINGTON, DC, 20005, US

(73) Assignee: PIONEER CORPORATION, Tokyo (JP)

(21) Appl. No.: 11/631,076

(22) PCT Filed: Jun. 30, 2005
(86) PCT No.: PCT/JP05/12034

§ 371 Date: Nov. 26, 2007

(30) Foreign Application Priority Data
Jun. 30, 2004 (JP) 2004-194446

(51) Int. Cl. G11B 33/02

(52) U.S. Cl. 720/603

(57) ABSTRACT

A recording medium drive device includes a tray to mount a cartridge 92, and a retaining member attached to the case through an attaching member 40A. The retaining member presses the front and rear end portions of the cartridge 92 to the tray. The retaining member includes a rotating member 44 attached to the attaching member 40A and the elastic retaining piece 45 fixed to the rotating member 44. The front and rear end portions of the elastic retaining piece 45 respectively extend from the rotating end portion of the rotating member 44. When the cartridge 92 is inserted, the rotating member 44 is operated to separate the front end portion of the elastic retaining piece 45 from the cartridge 92, and when the cartridge 92 reaches a specified position, the cartridge 92 is pressed by the both front and rear end portions of the elastic retaining piece 45.

### TECHNICAL FIELD

The present invention relates to a recording medium drive device in which a cartridge is pressed by a retaining member to a tray on which a cartridge type recording medium is mounted, the cartridge type recording medium having the cartridge in which a disc main body is housed.

### BACKGROUND ART

There has been used a recording/reproducing device for reproducing/recording information from/on an optical recording medium. The recording/reproducing device houses the recording medium therein and rotates the recording medium at high speed while data reading or writing is performed by a recording/reproducing mechanism inside the recording/reproducing device.

In addition to a bare disc type recording medium such as a CD (Compact Disc) which is used in a state where a recording surface thereof is exposed, the recording medium includes a cartridge type recording medium such as a MD (Mini Disc), a DVD-RAM (Digital Versatile Disc-Random Access Memory), a blue-ray disc and the like which is housed in a cartridge to protect the recording surface thereof. As a recording/reproducing device capable of performing data reading or writing on the cartridge type recording medium, there has been known a tray mounting type recording/reproducing device.

In the tray mounting type recording/reproducing device, a switch and the like are provided inside a case at a position near an entrance. The switch and the like touch a front end side of the cartridge to detect registered information and other information of the disc main body housed in the cartridge.

Due to the provision of the switch and the like, there is possibility that the front end side of the cartridge will lift up, so that a retaining member is conventionally attached to the case through an attaching member to press the cartridge toward the side of the tray.

An example of such prior art is an art in which a sheet metal is used as an attaching plate, and a retaining member is integrally formed with the sheet metal (see, for example, Patent Document 1).

The retaining member is a pair of front and rear plate-shaped members integrally formed with the attaching plate that is made from the sheet metal. A tip end and a rear end of the retaining member constantly bias a front end and a rear end of the cartridge.

The cartridge is inserted from the entrance in a condition where the cartridge is mounted on the tray. At this time, the front end and the rear end of the retaining member slide in press-contact with the cartridge.

[Patent Document 1] Japanese Patent Laid-Open Publication No. 2004-111008 (FIG. 4)

### DISCLOSURE OF THE INVENTION

### Problems to be Solved by the Invention

However, in the prior art, since the front end and the rear end (which are made from a pair of plate-shaped members) of the retaining member slide in press-contact with the cartridge, damage will be caused to the cartridge. Although many solutions are proposed to solve this problem such as using a material having excellent lubrication for the front end and the rear end of the retaining member or attaching rollers to the front end and the rear end of the retaining member, the effect for protecting the cartridge from being damaged is not sufficient.

Particularly, in a cartridge for blue-ray disc, since a large opened face is formed on its sliding surface and the opened face is dented compared to a peripheral portion, while the cartridge is moving, the front end and the rear end of the retaining member slide the peripheral portion, then fall into the opened face, and then is brought onto the peripheral portion, so that there is a concern that the operation will be unstable.

An object of the present invention is to provide, as an example, a recording medium drive device in which the cartridge will not be damaged by the retaining member even when the cartridge is being inserted into/ejected from the entrance.

### Means for Solving the Problems

A recording medium drive device according to the present invention includes: a case having an entrance for housing a cartridge type recording medium; a carrier adapted to be inserted into/ejected from the entrance and to mount the cartridge; and a retaining member attached to the case through an attaching member, the retaining member pressing a front end portion and a rear end portion of the cartridge to the carrier, in which the retaining member includes a rotating member rotatably attached to the attaching member and an elastic retaining piece fixed to the rotating member, the rotating member rotating about an axis intersecting an insertion/ejection direction of the cartridge, the elastic retaining piece having its front end portion and rear end portion respectively extended from a rotating end portion of the rotating member.

### BRIEF DESCRIPTION OF DRAWINGS

FIG. 1 is an exploded perspective view showing an entire recording medium drive device according to an embodiment of the present invention;

FIG. 2 is a front view showing the recording medium drive device with a clamp mechanism and a tray thereof removed;

FIG. 3 is an entire perspective view showing the recording medium drive device with the clamp mechanism and the tray thereof removed;

FIG. 4 is a front view showing the clamp mechanism;

FIG. 5 is a cross section taken along line V-V of FIG. 4;

FIG. 6 is a cross section taken along line VI-VI of FIG. 4;

FIG. 7 corresponds to FIG. 5, and shows a state where a damper is separated from a disc table;

FIG. 8, which corresponds to FIG. 6, explains the function of a retaining member;

FIG. 9, which corresponds to FIG. 6, explains the function of the retaining member; and

FIG. 10 is a plan view showing a cartridge type recording medium.

### EXPLANATION OF CODES

10 . . . case, 30 . . . tray (carrier), 40A . . . attaching member, 41 . . . clamper, 43 . . . retaining member, 44 . . . rotating member, 45 . . . elastic retaining piece, 46 . . . biasing member, 92 . . . cartridge

### BEST MODE FOR CARRYING OUT THE INVENTION

An embodiment of the present invention will be described below with reference to the attached drawings.

### [Brief Arrangement of Recording Medium Drive Device]

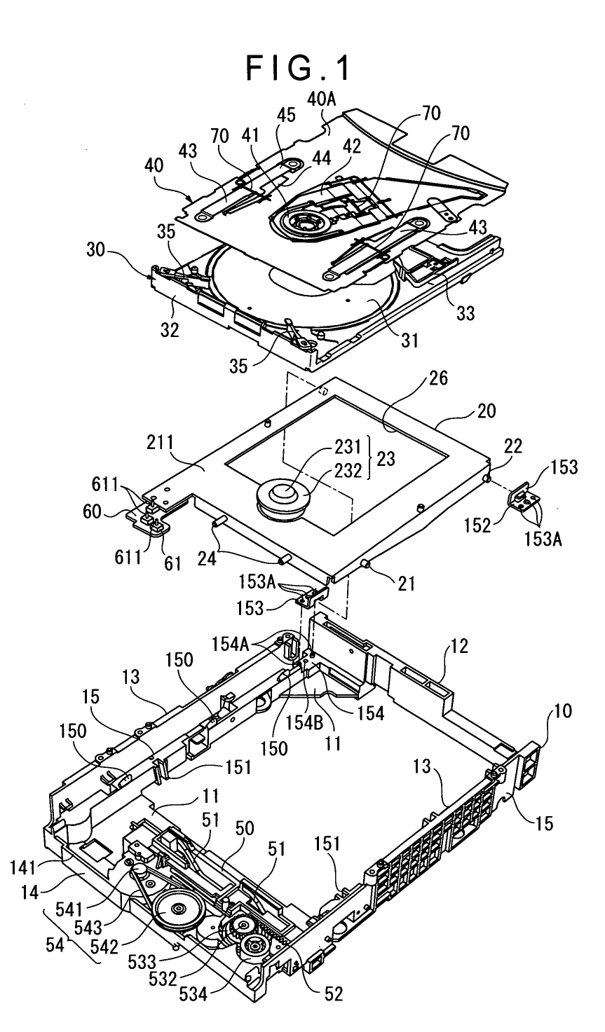

FIGS. 1 to 6 show a recording medium drive device of the present embodiment.

As shown in FIG. 1, the recording medium drive device of the present embodiment is adapted to record/reproduce information on/from a recording medium. The recording medium drive device includes a case 10 having a substantially rectangular shape in plan view, a base 20 attached inside the case 10, a tray 30 (a carrier) adapted to be inserted into/ejected from the case 10 through an entrance (not shown), a clamp mechanism 40 attached on an upper surface of the case 10, and a metal casing (not shown) to cover outer peripheral surface of the case 10.

[Recording Medium]

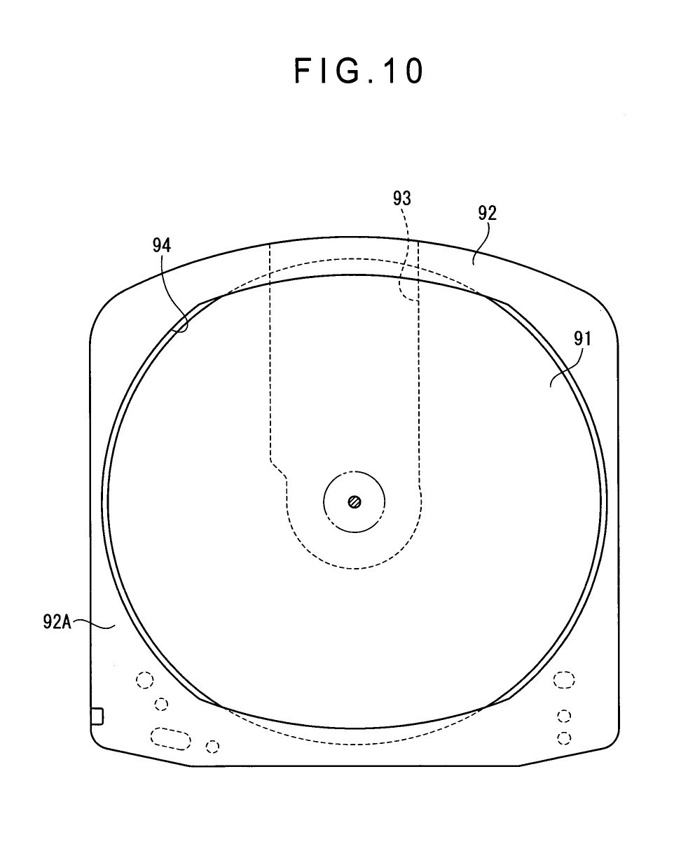

The recording mediums used in the recording medium drive device include a bare disc type recording medium such as a CD which is used as it is, and a cartridge type recording medium in which a disc main body 91 is housed in a cartridge 92 as shown in FIG. 10. The cartridge 92 of the cartridge type recording medium has an opening 93 formed from an outer circumference toward the center thereof. Recording/reproducing of the inside disc main body 91 can be conducted from the opening 93. The opening 93 is covered by a cover (not shown) for protecting the disc main body 91 when the recording/reproducing is not conducted.

The cartridge 92 shown in FIG. 10 is used for a blue-ray disc. The cartridge 92 has a large substantially circular opened face 94 formed in the central portion thereof. The opened face 94 is dented compared to a peripheral portion 92A.

A cartridge information portion is provided at one or both ends of the cartridge 92.

[Arrangement of Case]

The case 10 is made of a synthetic resin or the like. The case 10 includes a flat-plate shaped bottom portion 11 that is rectangular in plan view, a rear portion 12 formed integrally with the bottom portion 11 on one short edge thereof, a front portion 14 formed integrally with and uprightly from the bottom portion 11 on the other short edge thereof; two lateral portions 15 (both having substantially the same height as that of the rear portion 12) formed integrally with the bottom portion 11 on both long edges thereof, the lateral portions 15 and the rear portion 12 enclosing and defining an upper opening 13 facing the bottom portion 11.

The lateral portions 15, the front portion 14 and the rear portion 12 are provided on the edges of the bottom portion 11, forming an enclosed large cavity. The cavity of the bottom portion 11 is a space for housing an electric circuit (not shown), the electric circuit controlling operation of the recording medium drive device.

Sliding pieces 150 for slidably supporting the tray 30 are formed on inner walls of the lateral portions 15 along a front-rear direction. The base 20 is swingably attached to the rear side of the lateral portions 15.

The front portion 14 has a smaller length in an up-down direction as compared to the rear portion 12 and the lateral portions 15. A front opening 141 is formed on the upper side of the front portion, through which the tray 30 is ejected and retracted. An operating section (not shown) connected to the electrical circuit on the bottom portion 11 is provided on the front portion 14. The operating section includes an eject button for ejecting and retracting the tray 30, a volume control for controlling volume, an insertion hole of an earphone and the like.

A clamp mechanism 40, which is one of mechanisms for retaining the recording medium, is attached on the upper opening 13.

[Arrangement of Base 20]

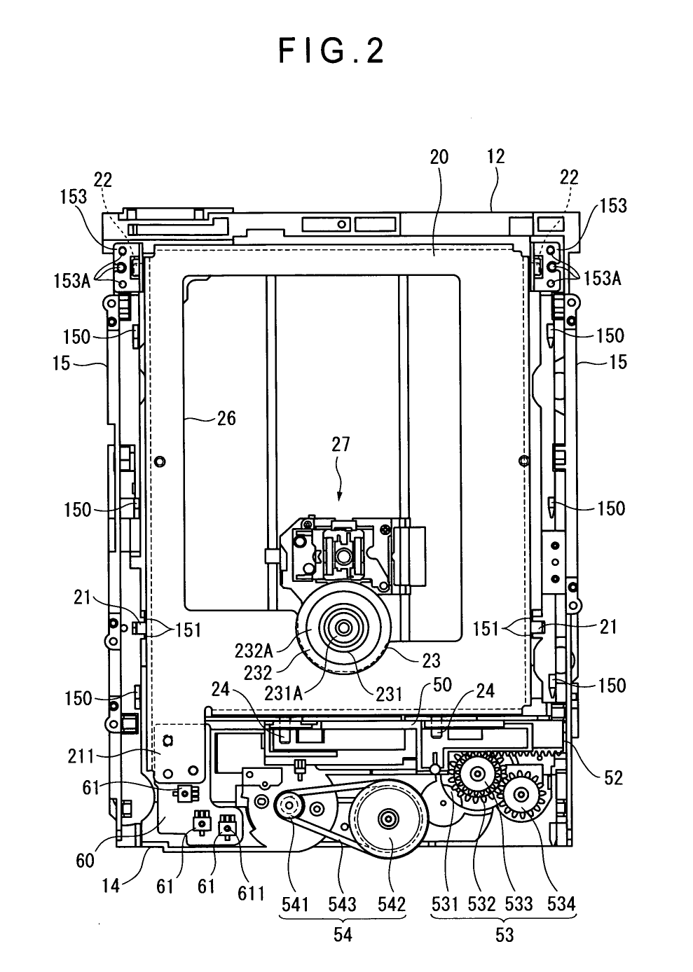

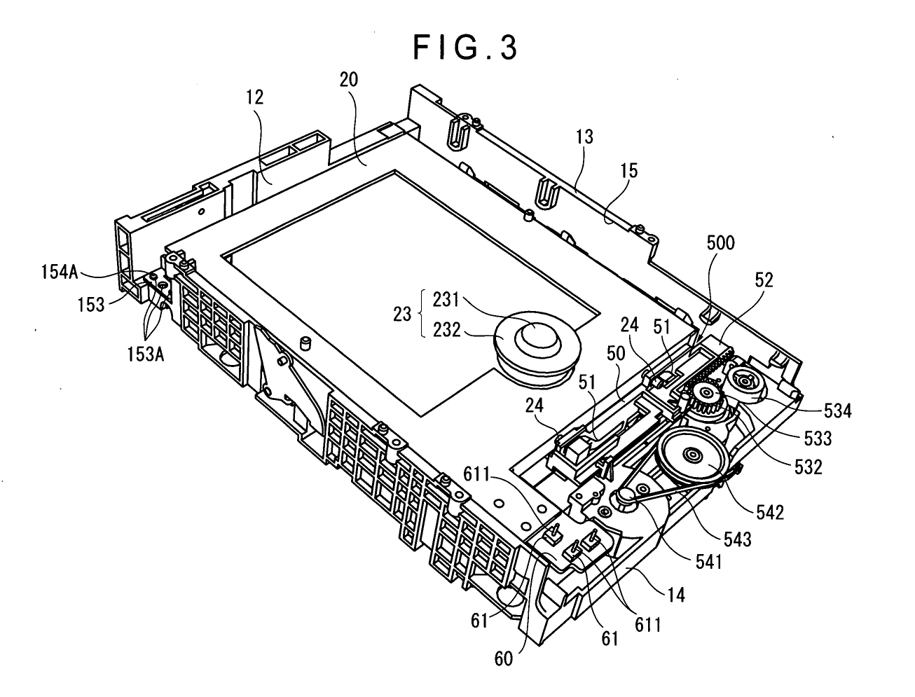

The base 20, as shown in FIGS. 2 and 3, is made by press-molding a metal plate. A disc table 23 is attached to the base 20 at a position away from the front side by a predetermined distance and substantially in the middle in a lateral direction. The disc table 23 is circular in plan view and rotatable about a rotation axis in the up-down direction. Further, the disc table 23 projects from an upper surface of the base 20 toward the upper side. A rotary drive mechanism (not shown) such as a motor is provided on a lower surface of the disc table 23, the rotary drive mechanism being electrically connected with the electrical circuit through, for example, a synthetic resin flexible substrate with a pattern wiring embedded therein. When an electric signal of drive command is transmitted from the electric circuit, the rotary drive mechanism rotates the disc table 23 at high speed.

The disc table 23 includes a mounting portion 232 for mounting the recording medium and a tapered portion 231 provided at the center of the mounting portion 232, the tapered portion 231 having a diameter gradually reduced toward the upper side. The tapered portion 231 is engaged with the opening 93 of the disc main body 91. As shown in FIG. 3, a magnet 231A is embedded in the tapered portion 231 on the upper side. A sheet 232A made of a synthetic resin is adhered on the mounting portion 232 on the upper side, the sheet serving as a surface protector of the recording medium as well as a slip stopper. The recording medium can be prevented from slipping off due to the sheet 232A even when the disc table 23 is rotated at high speed, so that no damage is caused to the recording surface of the recording medium.

A recording/reproducing mechanism setting hole 26 is formed in the base 20 on the rear side of the disc table 23. A recording/reproducing mechanism 27 is provided in the recording/reproducing mechanism setting hole 26. Incidentally, the recording/reproducing mechanism 27 is indicated only in FIG. 3 and omitted in other figures.

The recording/reproducing mechanism 27 records and/or reproduces information by irradiating a laser beam to the recording surface of the recording medium and is advanceable and retreatable in the front-rear direction of the recording/reproducing mechanism setting hole 26 of the base 20.

A detection board attaching portion 211 projecting toward the front side is formed on one corner of the front side of the mechanical base 20. A flat plate-shaped detection board 60 is fixed to the lower side of the detection board attaching portion 211. A detection switch 61 is formed uprightly toward the upper side on the detection board 60, the detection switch 61 being connected to the electric circuit through a wire (not shown) extending on the lower side of the base 20. Detection pins 611 are formed toward the upper side on a tip end of the detection switch 61.

[Attachment of Base 20 to Case 10]

A first shaft 21 and a second shaft 22 are provided on each lateral surface of the base 20, both the first shaft 21 and second shaft 22 projecting toward the lateral portion 15. The first shaft 21 is provided on the lateral surfaces of the base 20 at a position crossing a line extending from substantially the center of the disc table 23 toward the lateral portion 15, and the second shaft 22 is provided on the lateral surfaces of the base 20 at a position on the rear side.

A first guide groove 151 is integrally formed with the lateral portion 15 of the case 10 on the inner side of the lateral portion 15 at a position corresponding to the first shaft 21.

A shaft supporter 153 is fixed on an end portion of the rear side of the lateral portion 15. The shaft supporter 153 has a substantially L-shaped cross section, of which one half of the L-shape is provided with three shaft fixing holes 153A, the other half is provided with a second guide opening 152. The lateral portion 15 has, on the rear side, a flat portion 154 to which a shaft supporter 153 is attached, the flat portion 154 being provided with two bearing projections 154A projecting toward the upper side and a bearing hole 154B between the two bearing projections 154A.

[Arrangement of Tray 30]

The tray 30 is made of a synthetic resin such as ABS resin. The tray 30 includes a mounting surface 31 that is rectangular in plan view and a rising portion 32 rising from a periphery of the mounting surface 31 on the front side. Linear grooves (not shown) are integrally formed in lateral surfaces of the tray 30 on the lower side along a direction in which the tray 30 ejects and retracts. The sliding pieces 150 of the lateral portions 15 engage with the grooves. The tray 30 can eject and retract smoothly in the front-rear direction due to the grooves and the sliding pieces 150. The mounting surface 31 can mount either the cartridge type recording medium or the bare disc type recording medium, and is provided with a circular recessed portion for mounting the bare disc type recording medium.

A slider 33 made of a synthetic resin or the like is attached to the rear side of the tray 30, the slider 33 serving as a recording medium positioning member. The slider 33 is biased toward the front side by an elastic member (not shown) such as a spring.

Disc holders 35 are rotatably attached to both ends of the rising portion 32 of the tray 30.

Both ends of the front side of the mounting surface 31 of the tray 30 are each provided with a detection hole (not shown). When the tray 30 is housed in the case 10 and the base 20 swings to move the disc table 23 toward the side of the tray 30, the detection pins 611 of the detection board 60 attached to the base 20 also moves toward the side of the tray 30. At this time, the detection pins 611 pass through the detection hole 34 and project toward the upper side of the mounting surface 31. This arrangement is used for detecting the information recorded in the cartridge type recording medium when the recording medium mounted on the mounting surface 31 is the cartridge type recording medium.

The detection pins 611 disposed at the tip end of the detection switch 61 and projected from the mounting surface 31 are used for detecting the information of the recording medium from the cartridge information portion provided on the cartridge type recording medium. For example, there are some cartridge type recording media in which the state of writable or unwritable can be selected. To be specifically, in such cartridge type recording media, a cartridge information portion is provided for allowing or prohibiting writing in the cartridge 92. The cartridge information portion is closed to allow writing or is open to prohibit writing.

[Arrangement of Clamp Mechanism 40]

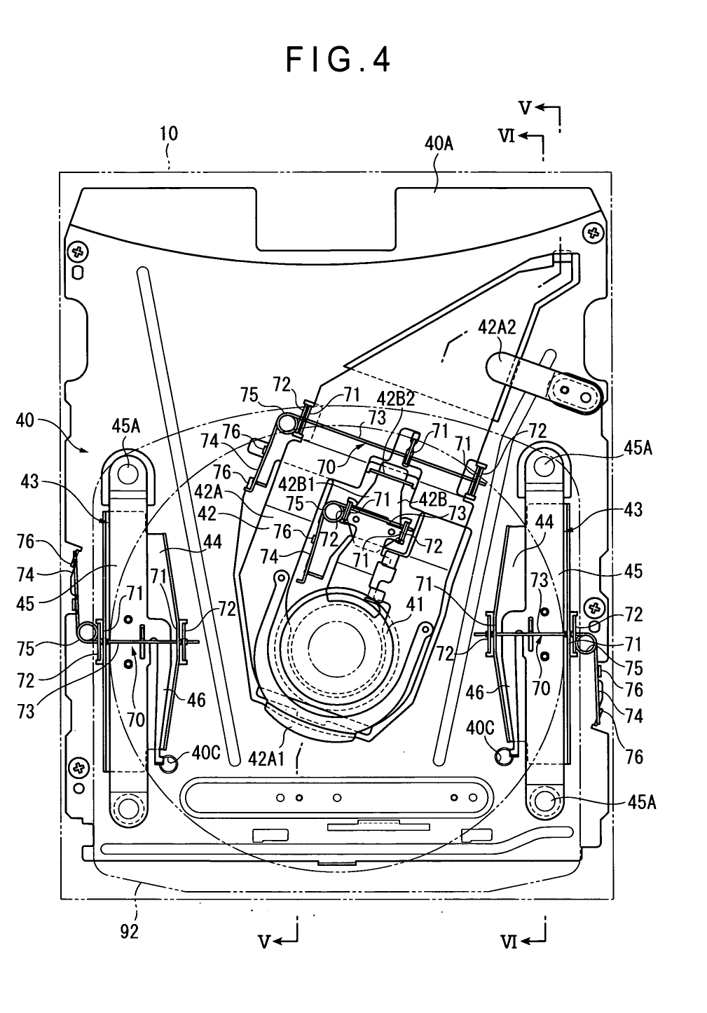

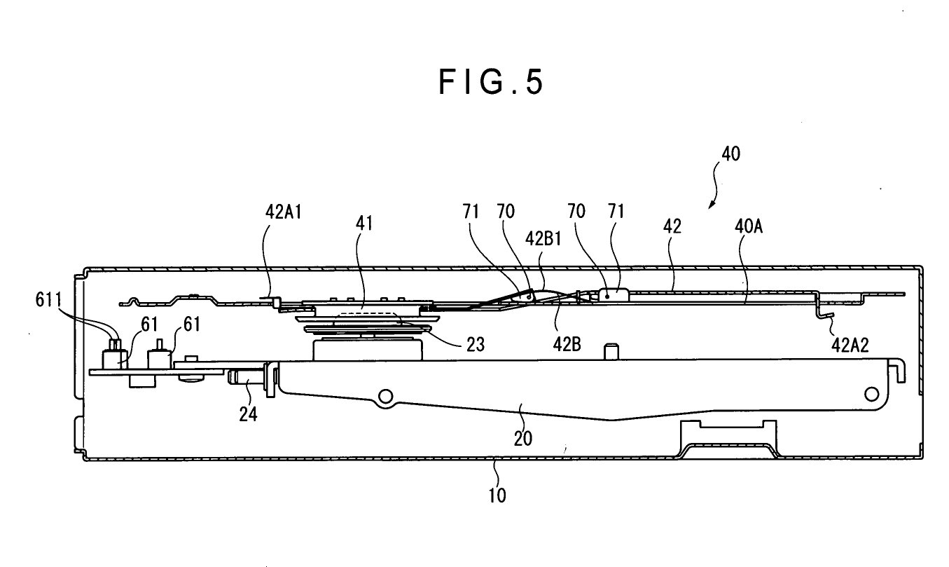

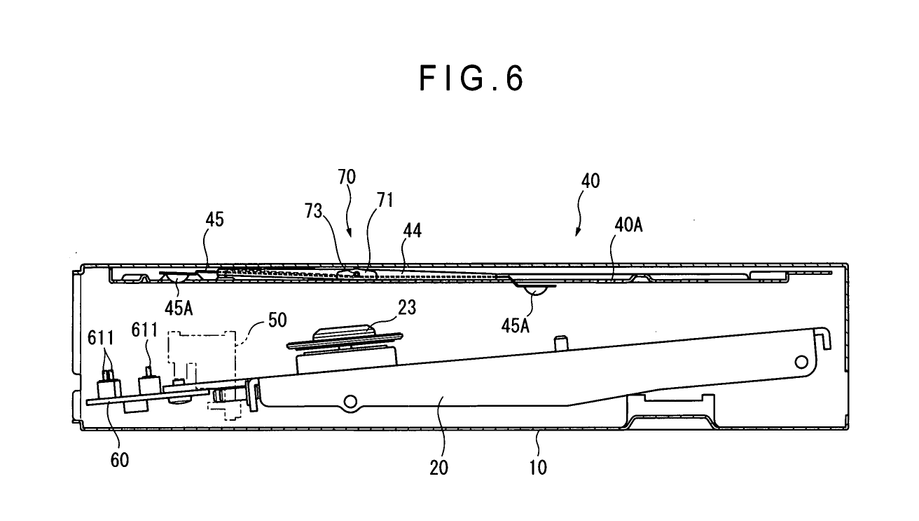

The detail structure of the clamp mechanism 40 is shown in FIGS. 4 to 6. Incidentally, the tray is omitted in FIGS. 5 and 6.

As shown in these figures, the clamp mechanism 40 includes a flat-plate shaped attaching member 40A attached to the case 10, a damper holder 42 attached to the flat-plate shaped attaching member 40A and supporting a damper 41 at a tip end thereof, and two retaining members 43 respectively provided on right and left sides of the damper holder 42. The retaining members 43 extend parallel to the advance/retreat direction of the cartridge 92, and the distance therebetween corresponds to the width of the cartridge 92.

The flat-plate shaped attaching member 40A is provided, at the center thereof, with an opening through which the damper holder 42 faces the disc table 23. Provided on two sides of the opening are another two openings through which the retaining members 43 face the cartridge 92.

The damper 41 is adapted to retain the bare disc or the disc main body inside the cartridge 92, each being engaged with the disc table 23, from being escaped from the disc table 23. The clamper 41 can approach or be separated from the disc table 23 due to the provision of the damper holder 42.

The damper 41 is made of a synthetic resin and has a disk-shaped metal member (not shown) embedded in the central portion thereof on the upper side. An upper end and a lower end of the damper 41 are respectively provided with a flange.

The damper holder 42 supports an outer periphery of the damper 41 in an ascendable/descendable manner. The damper holder 42 includes a holder main body 42A whose center portion is rotatably supported to the flat-plate shaped attaching member 40A through a rotary shaft 70, and an attitude retainer 42B for retaining the attitude of the damper 41 relative to the disc table 23 regardless of the rotation attitude of the holder main body 42A.

The holder main body 42A is a substantially flat-plate shaped rotation piece. A tip end portion and a rear end portion of the holder main body 42A are respectively provided with a stopper 42A1 for restricting the rotation of the holder main body 42A toward the side of the disc table 23 and a biasing portion 42A2 for biasing the rear end portion downwardly and biasing the tip end portion upwardly

The holder main body 42A includes a set (three pieces) of first supporting pieces 71 formed near the rotating center thereof by being cut and raised, each of the first supporting pieces 71 having a through-hole. Two second supporting pieces 72 are respectively formed by being cut and raised from the flat-plate shaped attaching member 40A to face two first supporting pieces 71 on both sides among the three first supporting pieces 71, each of the second supporting pieces 72 having a through-hole.

The rotary shaft 70 includes a supporting shaft 73 that passes through the through-holes of the first supporting pieces 71 and the through-holes of the second supporting pieces 72; a fall-off prevention shaft 74 for preventing the fall-off of the supporting shaft 73, the fall-off prevention shaft 74 being integrally formed with the supporting shaft 73 by bending one end of the supporting shaft 73; and a spiral spring member 75 provided between the supporting shaft 72 and the fall-off prevention shaft 73 for preventing the displacement of the supporting shaft 72 from the through-holes. The supporting shaft 72, the spring member 75 and the fall-off prevention shaft 74 are formed by bending a single elastic thread element (such as a wire). An end of the fall-off prevention shaft 73 is engaged with an engaging projection 76 formed on the flat-plate shaped attaching member 40A.

The rotary shaft 70 of this arrangement is installed by the steps of: setting the holder main body 42A to a predetermined position in the flat-plate shaped attaching member 40A, passing the end of the supporting shaft 73 of the rotary shaft 70 through the through-holes of the first supporting pieces 71 and the through-holes of the second supporting pieces 72, and engaging the fall-off prevention shaft 73 with the engaging projection 76.

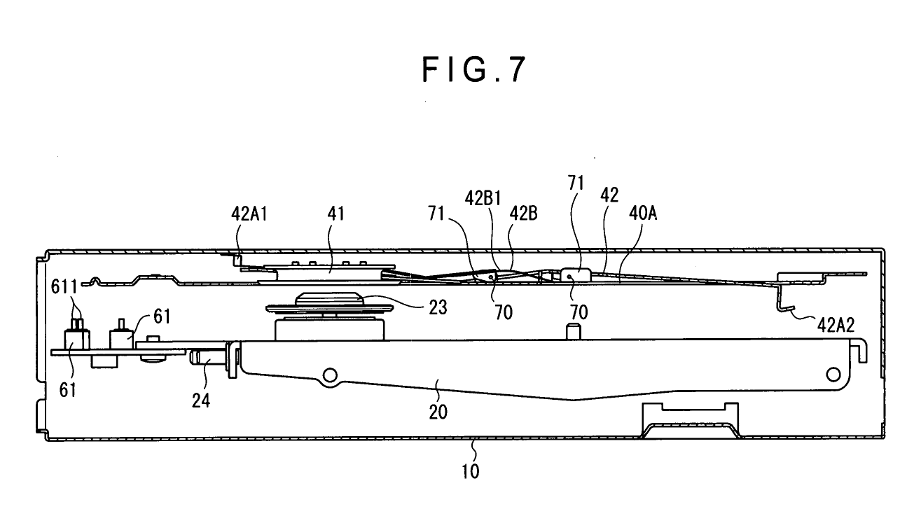

The attitude retainer 42B includes a leaf spring shaped engaging piece 42B1 whose front end portion is engaged between the flanges of the damper 41 and whose central portion is rotatably attached to the flat-plate shaped attaching member 40A through the rotary shaft 70, and a guide pin 42B2 for guiding the rear end portion of the engaging piece 42B1 so that the engaging piece 42B1 is biased upwardly. Owing to the engaging piece 42B1, the damper 41 can be separated from the disc table 23 in a state where its horizontal attitude is retained even when the holder main body 42A is inclined in a direction in which it is separated away from the disc table 23 (refer to FIG. 7).

The engaging piece 42B1 is a rotating piece which includes a pair of first supporting pieces 71 formed near the rotating center thereof by being cut and raised, each of the first supporting pieces 71 having a through-hole. Two second supporting pieces 72 are respectively formed by being cut and raised from the flat-plate shaped attaching member 40A to face the first supporting pieces 71, each of the second supporting pieces 72 having a through-hole. The rotary shaft 70 passes through the through-holes.

The retaining members 43 respectively press the front end portion and the rear end portion of the cartridge 92 to the side of the tray. The retaining members 43 each have a rotating member 44 attached to the flat-plate shaped attaching member 40A through the rotary shaft 70 and an elastic retaining piece 45 fixed to the rotating member 44, the axis of the rotary shaft 70 being substantially orthogonal to an insertion/ejection direction of the cartridge 92, a front end portion and a rear end portion of the elastic retaining piece 45 respectively extending from a rotating end portion of the rotating member 44. The portion of elastic retaining piece 45 extended from the rotating member 44 has spring force. Incidentally, in the present embodiment, the rotary shaft 70 is substantially orthogonal to the insertion/ejection direction of the cartridge 92, which means that the rotary shaft 70 may also intersect the insertion/ejection direction of the cartridge 92 at a predetermined angle, instead of being strictly limited to 90 degrees (right angle).

The rotating member 44 is a substantially flat-plate shaped rotating piece which includes a pair of first supporting pieces 71 formed near the rotating center thereof by being cut and raised, each of the first supporting pieces 71 having a through-hole. The second supporting pieces 72 are respectively formed by being cut and raised to face the first supporting pieces 71, each of the second supporting pieces 72 having a through-hole. The rotary shaft 70 passes through the through-holes.

The central portion of the elastic retaining piece 45 is fixed to the rotating member 44, and front end portion and the rear end portion of the elastic retaining piece 45 respectively have an substantially spherical abutting portion 45A abutting on the cartridge 92.

A biasing member 46 is connected with the central portion of the elastic retaining piece 45. The rear end portion of the elastic retaining piece 45 is constantly biased by the biasing member 46 toward the side of the cartridge. A tip end of the biasing member 46 is engaged with an engaging hole 40C formed in the flat-plate shaped attaching member 40A. When the elastic retaining piece 45 is biased by the biasing member 46, the attitude of the elastic retaining piece 45 is so retained that the abutting portion 45A on the front end side does not project from the lower face of the flat-plate shaped attaching member 40A.

The elastic retaining piece 45 and the biasing member 46 are made from a single leaf spring by press working or the like, and are arranged substantially in the same plane.

[Connection Between Base 20 and Tray 30]

Referring back to FIG. 1, an interlocking mechanism 500 is provided on the front side of the case 10. The interlocking mechanism 500 includes a drive cam 50 engaged with the base 20; a first rack 52 integrally formed with the drive cam 50; a gear mechanism 53 meshing with the first rack 52, the gear mechanism 53 including a first gear 531, a second gear 532, a third gear 533, and a fourth gear 534; a motor 54 meshing with the gear mechanism 53 and driven under control of the electrical circuit; and a second rack (not shown) provided on the lower side of the tray 30 and meshing with the gear mechanism 53.

A cam groove 51 extending in the lateral direction is provided on the rear side of the drive cam 50. A cam engaging pin 24 of the base 20 is engaged with the cam groove 51. The cam groove 51 is inclinedly formed with one end positioned on the upper side and the other end on the lower side. Since the drive cam 50 is reciprocated in the lateral direction, the cam engaging pin 24, climbing along the inclined portion, is moved between the two ends of the cam groove 51, and thereby the base 20 can be reciprocated in the up-down direction.

The first rack 52 formed on a lateral side of the drive cam 50 meshes with the third gear 533 of the gear mechanism 53. The second gear 532 having a larger diameter than that of the third gear 533 is integrally formed with the third gear 533 on the lower side of the third gear 533, and the second gear 532 meshes with the first gear 531 and the fourth gear 534.

The first gear 531 meshes with a motor gear 542 of the motor 54. The motor gear 542 is connected with a wheel 541 through a ring-shaped belt 543 made of a synthetic resin. A motor main body (not shown) is provided on the lower side of the wheel 541 through the case 10, and the drive force is directly supplied by the motor main body.

[Operation of Retaining Member]

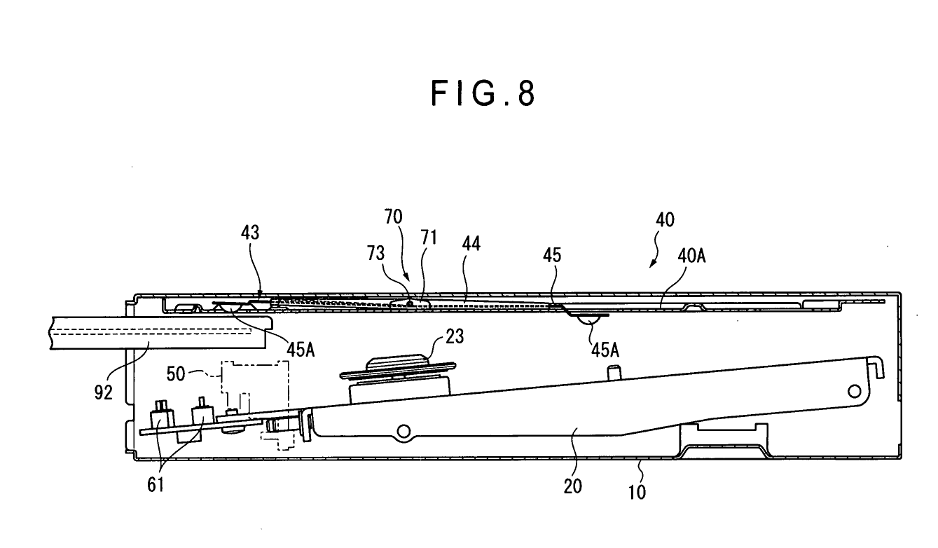

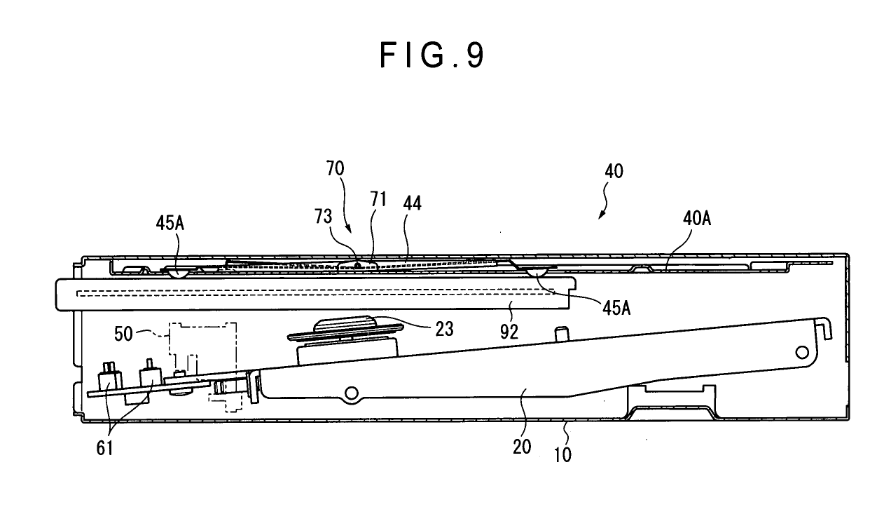

The operation of the retaining member 43 of the present embodiment will be described below with reference to FIGS. 8 and 9.

First, when the cartridge 92 is not inserted into the case 10, as shown in FIG. 8, a rear end portion (an end portion on the rear side) of the elastic retaining piece 45 of the retaining member 43 is biased to approach the base 20 by the elastic force of the biasing member 46 (refer to FIG. 4), and a front end portion (an end portion on the entrance side) of the elastic retaining piece 45 is separated from the base 20 and draw back from the lower face of the flat-plate shaped attaching member 40A. The disc table 23 is on standby at a lower position.

In this state, as shown in FIG. 8, when the cartridge 92 is inserted from the entrance, the cartridge 92 will advance in parallel with the lower face of the flat-plate shaped attaching member 40A. At this time, since the abutting portion 45A on the front side of the elastic retaining piece 45 is drawn back from the lower face of the flat-plate shaped attaching member 40A, it will not interfere with the cartridge 92.

Further, when the cartridge 92 keeps advancing, as shown in FIG. 9, the end portion of the cartridge 92 will abut on the abutting portion 45A on the rear end side (rear side) of the elastic retaining piece 45. Consequently, the abutting portion 45A is pushed up, the elastic retaining piece 45 rotates integrally with the rotating member 44, and the abutting portion 45A on the front end side (the entrance side) of the elastic retaining piece 45 pressed against the cartridge 92. In this state, four corner portions of the cartridge 92 are pressed onto the tray by the two retaining members 43.

When the cartridge 92 is set in a predetermined position, the base 20 rotates, the disc table 23 is engaged with a hole of the disc main body housed in the cartridge 92, and disc main body is clamped by the disc table 23 and the damper 41. Further, the detection switch 61 rises up with the rotation of the base 20 so as to be engaged with a specified position of the cartridge 92. At this time, although the cartridge 92 abutting on the detection switch 61 tries to lift up, the cartridge 92 can not lift up since it is pressed by the retaining member 43.

Through the above processes, the disc main body records/reproduces information on/from the recording medium while rotating together with the disc table 23.

When recording of information or the like is completed, the cartridge 92 is ejected from the case 10. The cartridge 92 is ejected in a state where it is mounted on the tray, and the abutment of the abutting portion 45A on the rear side of the elastic retaining piece 45 is released right after the cartridge 92 begins to move.

Consequently, the elastic retaining piece 45 and the rotating member 44 are rotated in the opposite direction to the previous direction due to the elastic force of the biasing member 46, and the abutting portion 45A on the front side is pushed up, so that the abutment thereof on the cartridge 92 is released. After that, the cartridge 92 will not abut on the elastic retaining piece 45 even when the cartridge 92 is moved in the ejection direction.

[Advantages of Recording Medium Drive Device of Present Embodiment]

The above described recording medium drive device has below advantages.

(1) The recording medium drive device includes the tray 30 adapted to be inserted into/ejected from the entrance of the case 10 and to mount the cartridge 92, and the retaining members 43 attached to the case 10 through the flat-plate shaped attaching member 40A, the retaining members 43 pressing the front end portion and the rear end portion of the cartridge 92 to the tray 30. Each retaining member 43 further includes the rotating member 44 attached to the flat-plate shaped attaching member 40A and the elastic retaining piece 45 fixed to the rotating member 44, the rotating member 44 rotating about an axis substantially orthogonal to the insertion/ejection direction of the cartridge 92, the front end portion and the rear end portion of the elastic retaining piece 45 respectively extending from the rotating end portion of the rotating member 44. With such an arrangement, when the cartridge 92 is inserted, the rotating member 44 is operated to separate the end portion of front side (the entrance side) of the elastic retaining piece 45 from the cartridge 92, and when the cartridge 92 reaches a predetermined position, the rotating member 44 is operated so that both the front end portion and rear end portion of the cartridge 92 are pressed by both the front end portion and rear end portion of the elastic retaining piece 45. Accordingly, the moving distance of the cartridge 92 under a condition where the cartridge 92 is pressed by both end portions of the cartridge 92 is shortened, so that it is less likely to cause damage on the surface of the cartridge 92. Further, the load applied to the motor for driving the carrying mechanism (the tray) can be reduced. Further, due to the provision of the retaining member 43, the cartridge 92 inserted into the case 10 is prevented from lifting up. Further, there is an alternative arrangement in which a sensor for detecting the rotation of the rotating member 44 is arranged at a suitable position (for example, a position near the rear end portion of the elastic retaining piece 45), so that the insertion of the cartridge 92 into a predetermined position can be detected, and the disc table 23 begins to rotate a preset time later from the detection.
(2) Since there are two retaining members 43 provided in alignment in parallel with each other in the direction substantially orthogonal to the insertion/ejection direction of the cartridge 92, the four corner portions of the cartridge 92 (which has a rectangular shape in plan view) are pressed by the retaining members 43, so that the cartridge 92 can be effectively prevented from lifting up.
(3) Since both the flat-plate shaped attaching member 40A and the rotating member 44 are flat-plate shaped, thickness of the whole recording medium drive device can be reduced by attaching the rotating member 44 to the attaching member 40A in an overlapped manner.
(4) Since the elastic retaining piece 45 is connected with the biasing member 46 which constantly biases the rear end portion of the elastic retaining piece 45 toward the side of cartridge 92, the front end portion of the elastic retaining piece 45 is normally retained so as to be separated from the cartridge 92. Accordingly, when the cartridge 92 is inserted, the front end portion of the elastic retaining piece 45 is prevented from abutting on the cartridge 92 by error, so that no damage is caused. When the end portion of the cartridge 92 reaches the rear end portion of the elastic retaining piece 45, the rear end portion of the elastic retaining piece 45 moves to make the elastic retaining piece 45 and the rotating member 44 rotate. Since the cartridge 92 is pressed by both end portions of the elastic retaining piece 45, the lifting up of the cartridge 92 can be suppressed.
(5) Since the elastic retaining piece 45 and the biasing member 46 are made from a single leaf spring, not only these components can be easily manufactured, but also the thickness of the device can be reduced.
(6) Since the front end portion and the rear end portion of the elastic retaining piece 45 are respectively provided with the substantially spherical abutting portion 45A, even when the cartridge 92 is moved under a condition where the cartridge 92 abuts on both end portions of the elastic retaining piece 45, the surface of the cartridge 92 will not be damaged due to the substantially spherical surface of the abutting portion 45A. Further, the sliding can be further smoothened by providing a roller to the abutting portion 45A of the elastic retaining piece 45.
(7) Since the tip end of the biasing member 46 is engaged with the engaging hole 40C formed in the flat-plate shaped attaching member 40A, even when the device is dropped by accident and therefore is impacted, the elastic retaining piece 45 and the biasing member 46 can be prevented from being displaced, so that the retaining member 43 can operate more precisely.
(8) The rotary shaft structure is provided in which the holder main body 42A, the engaging piece 42B1 and the rotating members 44 are respectively rotatably attached to the flat-plate shaped attaching member 40A through the rotary shafts 70. The rotary shaft structure includes the first supporting pieces 71 respectively provided near the rotating centers of the holder main body 42A, the engaging piece 42B1 and the rotating members 44, each of the first supporting pieces 71 having a through-hole, and the second supporting pieces 72 formed on the flat-plate shaped attaching member 40A to face the first supporting pieces 71, each of the second supporting pieces 72 having a through-hole. Each of the rotary shafts 70 includes the supporting shaft 73 that passes through the through-holes of the first supporting pieces 71 and the through-holes of the second supporting pieces 72, and a fall-off prevention shaft 74 for preventing the fall-off of the supporting shaft 73, the fall-off prevention shaft 74 being integrally formed with the supporting shaft 73 by bending one end of the supporting shaft 73. With such an arrangement, by passing the tip end portion of each of the supporting shafts 73 through the through-holes, the holder main body 42A, the engaging piece 42B1 and the rotating members 44 can be easily attached to the flat-plate shaped attaching member 40A with the rotary shafts 70. Further, since fall-off of the rotary shafts 70 are prevented by the fall-off prevention shafts 74, the rotary shafts 70 can be prevented from being dropped from the flat-plate shaped attaching member 40A by error. Further, since the supporting shaft 73 and the fall-off prevention shaft 74 of the rotary shaft 70 are integrally formed, the shape of the rotary shaft 70 in plan view can be easily formed into L-shape or other shape, so that the rotary shaft structure can be made thin, and thereby the thickness of the recording medium drive device can be reduced.
(9) Since the spring member 75 is provided between the supporting shaft 73 and the fall-off prevention shaft 74 for preventing the displacement of the supporting shaft 73 from the through-holes, the play can be restrained when installing the holder main body 42A, the engaging piece 42B1 and the rotating members 44 to the flat-plate shaped attaching member 40A, so that the rotary shaft 70 can be prevented from being removed by error.
(10) Since the supporting shaft 73, the spring member 75 and the fall-off prevention shaft 74 are formed by bending a single elastic thread element, not only the structure of the rotary shaft 70 is simplified, but also the manufacture of the rotary shaft 70 becomes easy.

[Modifications]

It is to be understood that the recording medium drive device of the present invention is not limited to the embodiment described above, but various modifications can be made without departing from the spirit and scope of the present invention.

Although the present embodiment describes a recording medium drive device that can be used for both the cartridge type recording medium and the bare disc type recording medium, the present invention is not limited thereto. The present invention may also be a recording medium drive device that can only be used for the cartridge type recording medium.

Further, the rotary shaft 70 may also be formed by a single shaft element whose both ends are each engaged by an engaging element such as a C-ring.

Further, the number of the retaining member 43 may alternatively be one, three or more, instead of two.

Although the elastic retaining piece 45 is connected with the biasing member 46 that constantly biases the rear end portion of the elastic retaining piece 45 toward the side of cartridge 92 in the present embodiment, the biasing member 46 does not have to be provided in the present invention. For example, there is an alternative arrangement in which the position of the inserted cartridge 92 is detected by a light sensor or the like, and the rotating member 44 is rotated based on the detection.

[Effects of Embodiment]

The recording medium drive device of the present embodiment includes the case having an entrance for housing a cartridge type recording medium, the tray 30 adapted to be inserted into/ejected from the entrance and to mount the cartridge 92, and the retaining members 43 attached to the case 10 through the flat-plate shaped attaching member 40A, the retaining members 43 pressing the front end portion and the rear end portion of the cartridge 92 to the tray 30. Each retaining member 43 further includes the rotating member 44 rotatably attached to the flat-plate shaped attaching member 40A and the elastic retaining piece 45 fixed to the rotating member 44, the rotating member 44 rotating about an axis substantially orthogonal to the insertion/ejection direction of the cartridge 92, the front end portion and the rear end portion of the elastic retaining piece 45 respectively extending from the rotating end portion of the rotating member 44. With such an arrangement, when the cartridge 92 is inserted, the rotating member 44 is operated to separate the end portion of front side of the elastic retaining piece 45 from the cartridge 92. When the cartridge 92 reaches a predetermined position, the rotating member 44 is operated to make both the front end portion and rear end portion of the elastic retaining piece 45 pressing both the front end portion and rear end portion of the cartridge 92. Accordingly, the moving distance of the cartridge 92 under a condition where the cartridge 92 is pressed by two end portions of the elastic retaining piece 45 is shortened, so that it is less likely to cause damage on the surface of the cartridge 92. Further, the load applied to the motor for driving the carrying mechanism is reduced. Further, the lifting up of the cartridge 92 can be suppressed due to the provision of the elastic retaining piece 45.

### INDUSTRIAL APPLICABILITY

The present invention can be used as a recording medium drive device in which a cartridge is pressed by a retaining member to a tray on which a cartridge type recording medium is mounted, the cartridge type recording medium having the cartridge in which a disc main body is housed.

1. A recording medium drive device comprising:
a case having an entrance for housing a cartridge type recording medium;
a carrier adapted to be inserted into/ejected from the entrance and to mount the cartridge; and
a retaining member attached to the case through an attaching member, the retaining member pressing a front end portion and a rear end portion of the cartridge to the carrier,
wherein the retaining member includes a rotating member rotatably attached to the attaching member and an elastic retaining piece made from a single leaf spring, the rotating member rotating about an axis intersecting an insertion/ejection direction of the cartridge, the elastic retaining piece having its central portion fixed to the rotating member and its front end portion and rear end portion respectively extended from a rotating end portion of the rotating member.

2. The recording medium drive device according to claim 1, wherein
the retaining member includes a plurality of the retaining members disposed in alignment in a direction intersecting the insertion/ejection direction of the cartridge.

3. The recording medium drive device according to claim 1, wherein
the attaching member and the rotating member are respectively substantially flat-plate shaped.

4. The recording medium drive device according to claim 1, wherein
the elastic retaining piece is connected with a biasing member that constantly biases the rear end portion of the elastic retaining piece toward the side of cartridge.

5. The recording medium drive device according to claim 4, wherein
the elastic retaining piece and the biasing member are made from a single leaf spring.
